(19) United States
(12) Patent Application Publication
(10) Pub. No.: US 2006/0259241 A1
(43) Pub. Date: Nov. 16, 2006

(54) Mobile device

(76) Inventor: Tomas Nylen, Upplands Vasby (SE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/398,232

(22) Filed: Apr. 5, 2006

(30) Foreign Application Priority Data
Apr. 7, 2005 (EP) EP 05007644.7

(51) Int. Cl. G01C 21/00

(52) U.S. Cl. 701/216

(57) ABSTRACT

The invention relates to a mobile device that includes a positioning unit that is adapted to determine the position of the device, and a movement sensor that is adapted to detect a movement of the device. When the positioning unit is requested to determine the position, the device is adapted to use the last position as new position if no movement of the device has been detected by the sensor since the last position was determined. A new position is ascertained if a movement of the device has been detected by the sensor since the last position was determined.

### REFERENCE TO RELATED APPLICATIONS

This application claims the benefit of the priority date of European application EP 05 007 644.7, filed on Apr. 7, 2005, the contents of which are herein incorporated by reference in their entirety.

### FIELD OF THE INVENTION

The present invention relates to a mobile device comprising a positioning unit, the positioning unit being provided to determine the position of the device. The present invention also relates to a method of determining the position of a mobile device.

### BACKGROUND OF THE INVENTION

Mobile devices, such as mobile phones, personal digital assistants (PDA), lap top computers and vehicles, may comprise a positioning unit, by means of which the geographical position of the device may be determined.

A positioning unit requires a receiver for receiving signals from geographical points that are well defined whereby the position might be determined. Some of the most widely used positioning units use signals from satellites or base stations in ground based communication systems in order to make the determination.

There are different global navigation satellite systems for global positioning services for civilian use such as the Global Positioning System (GPS) from the United States, the Global Navigation Satellite System (GLONASS) from Russia and the Galileo system from Europe. There are also different ground based systems that can be used for positioning purposes, such as the Global System for Mobile communication (GSM).

A receiver adapted to determine a position according to any of these systems receives signals from well-defined geographical points within the system, such as satellites or base stations, and makes the determination of the position from these signals. It is also possible to have a receiver that determines a position with the aid of two or more different positioning systems in order to increase the accuracy of the determination or the availability of the system.

One of the major problems with mobile devices is power consumption and a receiver in a positioning unit requires power each time the receiver receives signals in order to determine the position.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The invention is directed to a positioning unit for a mobile device with low power consumption, but yet accurate and updated with regards to the position of the mobile device.

The invention is also directed to a positioning unit that knows when a new determination of the position is required and that, for example, receives signals for determination of the position only when a new determination is required.

In one embodiment the invention includes a device that comprises a movement sensor, which movement sensor is adapted to detect a movement of the device.

In one embodiment the invention provides that when the positioning unit is requested to determine the position, the positioning unit is adapted to use the last position as a new position if no movement of the device has been detected by the sensor since the last position was determined, and that the positioning unit is adapted to determine a new position if a movement of the device has been detected by the sensor since the last position was determined.

Consequently if the device has not been moved since the last time a position was determined, no new position is determined and thus no new signals are received for determination of the position, thus saving energy since a correct position can be presented without using the energy-consuming receiver in the positioning unit.

Different kinds of movement sensors may be used in accordance with the invention depending on the requirements of the sensor and the use of the mobile device. The sensor may be a low cost sensor, such as a mechanical movement sensor for consumer mobile devices that are very cost sensitive. The sensor may also be a high sensitivity movement sensor for mobile devices and applications with specific requirements.

In one embodiment, calm movements within a small area may not be regarded as an actual movement, thus presenting the last position as a new position without making a new determination of the position. In order to achieve this, the invention, in one embodiment, comprises a calculating unit adapted to calculate the distance of a movement from the last position by means of information from the sensor. In this embodiment the sensor is adapted to present a position as being the same position as the last position if the calculating unit indicates that the device has been moved within a predefined radius around the last position, and the sensor is adapted to determine a new position if the calculating unit indicates that the device has been moved outside of the predefined radius.

In another embodiment the invention comprises a positioning unit with a receiver adapted to receive signals from one or more available positioning systems, such as a GPS receiver and/or Galileo receiver and/or a GLONASS receiver, or a receiver adapted to receive signals from any ground based system, such as a GSM receiver.

In yet another embodiment of the invention the mobile device may be a mobile phone, a PDA, a lap top computer, or a vehicle, such as a car or a boat.

Another embodiment of the invention comprises a method of determining the position of a mobile device comprising a positioning unit. The inventive method teaches that when the positioning unit is requested to determine the position, the last position is used as new position if the device has not been moved since the last position was determined, and that a new position is determined if the device has been moved since the last position was determined.

An alternative embodiment of the method comprises the calculation of the distance of a movement from the last position, that a position is regarded as being the same position as the last position if the device has been moved within a predefined radius around the last position, and that a new position is determined if the device has been moved outside of the predefined radius.

The advantages of a mobile device or a method according to the present invention are, for example, that the positioning information of the mobile device will always be updated and accurate without the constant use of the receiver belonging to the positioning unit, thus saving power, which is important when it comes to mobile devices.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

A mobile device and a method according to the present invention will now be described in detail with reference to the accompanying drawings, in which:

FIG. 1 is a schematic and simplified illustration of a mobile device according to one embodiment of the invention, and

FIG. 2 is a flow chart illustrating a determination of the position of the mobile device according to another embodiment of the invention.

### DETAILED DESCRIPTION OF THE INVENTION

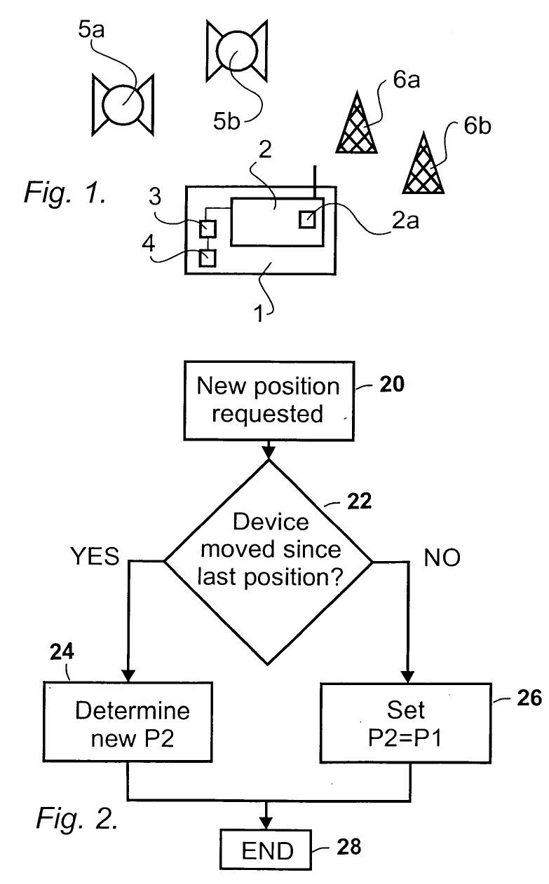

According to one embodiment, the invention will be described with reference to FIG. 1, showing a mobile device 1 comprising a positioning unit 2, which positioning unit 2 is adapted to determine the position P1 of the device 1. The device according to the invention also comprises a movement sensor 3 that is adapted to detect a movement of the device.

When the positioning unit is requested to determine the position, the positioning unit 2 is adapted to use the last position P1 as a new position P2 if no movement (or alternatively no substantial movement) of the device 1 has been detected by the sensor 3 since the last position P1 was determined. Further, the positioning unit 2 is adapted to determine a new position P2 if a movement of the device 1 has been detected by the sensor 3 since the last position P1 was determined.

FIG. 2 is a flow chart illustrating how the inventive mobile device is adapted to determine its position in accordance with one embodiment of the invention. In one embodiment, the device is adapted to: ascertain that a new position is requested at 20. A query is then made at 22 to determine whether the device moved since last position determination at 24. If the answer is yes at 22, a new position P2 is determined at 24, and if the answer is no at 22, the new position P2 is set to the same value as the old position P1 at 26. The operation then ends at 28.

The sensor 3 may be a low cost sensor, for example, a mechanical movement sensor, or a high sensitive movement sensor depending on requirements in the specific embodiment.

A high sensitivity movement sensor might for instance be able to detect smooth and slow movements, such as the movements of a boat at anchor but moving in the sea. This embodiment proposes that the device 1 comprises a calculating unit 4 adapted to calculate the distance of a movement from the last position by means of information from the sensor 3. The sensor 3 is adapted to present a position as being the same position as the last position if the calculating unit 4 indicates that the device 1 has been moved within a predefined radius around the last position, and the sensor 3 is adapted to determine a new position if the calculating unit 4 indicates that the device 1 has been moved outside of the predefined radius. Alternatively, the sensor 3 and calculating unit 4 may operate in conjunction with a controller (either integrated therewith or a separate component) to keep track of the amount of movement and allow for the radius to be user-defined or otherwise variable. Therefore such a device 1 might be adapted to allow a user to set the radius according to his/her own requirements.

In another embodiment, the mobile device 1 may comprise a positioning unit 2 with a receiver 2a adapted to receive signals from one or more available global navigation satellite systems 5a, 5b, such as a GPS receiver and/or Galileo receiver and/or a GLONASS receiver. Alternatively, or additionally, the receiver 2a is adapted to receive signals from one or more available ground based systems 6a, 6b, such as a GSM receiver.

The present invention might be implemented in several different kinds of mobile devices and it should be understood that the invention is not restricted to any one kind of mobile device. An inventive mobile device 1 might for instance be a handheld device, such as a mobile phone, a PDA, or a lap top computer, or it might be a vehicle, such as a car or a boat.

The present invention also relates to a method of determining the position of a mobile device 1 comprising a positioning unit 2. This method will now be described with renewed reference to FIG. 1. According to one embodiment, the invention provides that when the positioning unit 2 is requested to determine the position, the last position P1 is used as the new position P2 if the device 1 has not been moved since the last position P1 was determined, and that a new position P2 is determined if the device 1 has been moved since the last position P1 was determined.

An alternative embodiment of the inventive method comprises calculating the distance of a movement from the last position P1. In one example, a position is regarded as being the same position as the last position P1 if the device 1 has been moved within a predefined radius around the last position P1, and that a new position P2 is determined if the device 1 has been moved outside of the predefined radius.

In one embodiment, the method contemplates the reception of signals from one or more available global navigation satellite systems 5a, 5b, such GPS, Galileo, or GLONASS, and/or from one or more available ground based systems 6a, 6b, such GSM, in order to determine the position.

The method according to the invention is not restricted to be used with any specific kind of mobile device. It may for instance be implemented in handheld devices, such as a mobile phone, a PDA, or a lap top computer, or a vehicle, such as a car or a boat.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising.” Additionally, the term “exemplary” is intended to indicate an example and not a best or superior aspect or implementation.

1. A mobile device, comprising:
a positioning unit adapted to determine a position of the device; and
a movement sensor adapted to detect a movement of the device,
wherein the positioning unit is further adapted to use a last determined position of the device as a new position thereof if no substantial movement of the device has been detected by the sensor since the last position was determined, and wherein the positioning unit is still further adapted to determine a new position of the device if a movement of the device has been detected by the sensor since the last position was determined.

2. The mobile device of claim 1, wherein the sensor comprises a mechanical movement sensor.

3. The mobile device of claim 1, wherein the sensor comprises a high sensitivity movement sensor.

4. The mobile device of claim 3, the device further comprising a calculating unit adapted to calculate the distance of a movement from the last determined position by means of information from the movement sensor, wherein the sensor is adapted to present a new position as being the same position as the last determined position if the calculating unit indicates that the device has been moved within a predefined radius around the last determined position, and wherein the sensor is adapted to determine a new position if the calculating unit indicates that the device has been moved outside of the predefined radius.

5. The mobile device of claim 1, wherein the positioning unit comprises a receiver adapted to receive signals from one or more available global navigation satellite systems or from one or more available ground based systems, or both.

6. The mobile device of claim 1, wherein the device comprises one or more of a mobile phone, a personal digital assistant, or a lap top computer.

7. The mobile device of claim 1, wherein the device comprises a car or a boat.

8. A method of determining a position of a mobile device comprising:
requesting a positioning unit to determine a position of the mobile device;
determining whether the mobile device has moved substantially from a last position where a last position determination was made using a movement sensor;
using the last position determination as a new position determination if the mobile device has not moved substantially; and
determining the new position of the mobile device using the positioning unit if the mobile device has moved substantially.

9. The method of claim 8, wherein the mobile device has not moved substantially if the positioning unit determines the new position as being within a predefined radius from the last position determination.

10. The method of claim 8, wherein the mobile device has moved substantially if the positioning unit determines the new position as not being within a predefined radius from the last position determination.

11. The method of claim 8, wherein the positioning unit uses signals from one or more available global navigation satellite systems or from one or more available ground based systems, or both, in order to determine the position of the mobile device when the mobile device has moved substantially.

12. A mobile device, comprising:
a positioning unit configured to determine a position of the mobile device; and
a movement sensor configured to provide data to the positioning unit reflecting a movement of the mobile device,
wherein the positioning unit is further configured to determine a most recent previous position of the mobile device as a present position of the mobile device if the movement sensor data reflects no substantial movement of the mobile device since the most recent previous position was determined.

13. The mobile device of claim 12, wherein the positioning unit is further configured to determine no substantial movement of the mobile device if the movement sensor data indicates an amount of movement of the mobile device within a predetermined radius of the most recent previous position.

14. The mobile device of claim 12, further comprising a receiver configured to receive signals from one or more available global navigation satellite systems, or one or more available ground based systems, or both, and wherein the positioning unit is configured to use the received signals to determine the present position when the movement sensor data reflects a substantial movement of the mobile device since the most recent previous position was determined.

15. The mobile device of claim 14, wherein the positioning unit activates the receiver to receive signals only when the movement sensor data reflects a substantial movement of the mobile device since the most recent previous position was determined.

16. The mobile device of claim 14, wherein the positioning unit is further configured to determine substantial movement of the mobile device if the movement sensor data indicates an amount of movement of the mobile device beyond a predetermined radius of the most recent previous position.

17. The mobile device of claim 13, further comprising a calculating unit operably coupled to the movement sensor, and configured to calculate a distance between the most recent previous position and the present position of the mobile device based on the movement sensor data, and provide the calculated distance to the positioning unit.
